(19) United States
(12) Patent Application Publication
(10) Pub. No.: US 2015/0217938 A1
(43) Pub. Date: Aug. 6, 2015

(54) Hydraulic Device With Heating Element

(71) Applicant: Ventura Hydraulic & Machine Works, Inc., Ventura, CA (US)

(72) Inventors: Fred Malzacher, Venutra, CA (US); Carl Van Wezel, Santa Rosa Valley, CA (US)

(73) Assignee: Ventura Hydraulic & Machine Works, Inc., Ventura, CA (US)

(21) Appl. No.: 14/173,118

(22) Filed: Feb. 5, 2014

(51) Int. Cl. B65G 7/00; B66F 13/00; B66F 19/00

(52) U.S. Cl. CPC B65G 7/00; B66F 19/00; B66F 13/00

(57) ABSTRACT

A hydraulic device is provided capable of moving heavy loads along a slotted track. The hydraulic device has a cylinder and piston unit, a jack that is connected to one or more ratcheting claws, and a sliding member having slots for placement of one or more ratcheting claws. To prevent brittle fracture of the hydraulic device during the movement of heavy loads under extreme cold conditions, the hydraulic device has a chamber for placement of heatable members that heat various elements of the hydraulic device, thereby reducing the likelihood of brittle fracture of the hydraulic device during operation. The hydraulic device may have one or more pairs of tandem ratchet claws that evenly distribute load forces along the slotted track. The device may also have detachable side weldments that hold the jack and claws for easy placement and removal of the device on a beam.

### CROSS REFERENCE TO RELATED APPLICATIONS

None

### BACKGROUND OF THE INVENTION

1. Field of the Invention

This invention relates to a hydraulic device, and more specifically, to a hydraulic device for ratcheting forward heavy loads for use in extremely cold temperatures.

2. Background Information

It is frequently necessary to move heavy objects, many times in excess of a million pounds, from one location to another. One way to move these heavy objects is to place such objects on skids and push or pull the objects along a track. The use of hydraulic pumps to facilitate movement of these objects along tracks is common, yet there still remains room to improve the structural stability of these hydraulic devices, especially in extreme environmental conditions, where stress and strain on the devices can break such devices.

The use of hydraulic cylinders to effectuate movement of extremely heavy loads is known in the art. U.S. Pat. No. 4,212,450 to Lambert is directed to a hydraulic-cylinder-driven jacking apparatus moving on a rail with slots and a pawl carriage. The apparatus comprises a load frame adapted to move relative to a rail having single slots longitudinally spaced there along. The reciprocating strokes of the hydraulic actuator produce alternate incremental movements of the load frame and of the carriage as the pawl members fall into successive slots as the apparatus moves along the rail.

U.S. Pat. No. 4,544,135 to Albaugh is directed to a skidding system having thick cover plates pre-cut with holes fixed to the tops of skid beams, which engage holes in the cover plates to anchor the ends of a hydraulic cylinder. Yet another hydraulic device is disclosed in U.S. Pat. No. 4,923,174 to Loechner, which is directed to an apparatus for bi-directionally moving heavy objects along rails using a hydraulic ratcheting device. However, these and other devices have not been specifically designed to be used in extremely cold temperatures, which can cause breakdown of the devices. Devices in the prior art have also not been designed to operate smoothly if there is ice buildup along the track or directly on the hydraulic device itself.

For these reasons, there is a need for devices that can move heavy objects in extremely cold conditions without the fear that these devices will undergo brittle fracture when exposed to high load forces. The claimed invention provides for device that reduces brittle fracture during exposure to high loads under low temperature conditions, as well as provide a means for smooth movement of heavy objects along a track having ice buildup.

### SUMMARY OF THE INVENTION

The present invention is directed to a hydraulic ratcheting device that pushes or pulls objects on a skid, the devices having a chamber for insertion of a heatable member. It is a purpose of the present invention to provide a hydraulic ratcheting jack that can withstand extreme load forces at low temperatures without breaking. By providing one or more heating chambers within the hydraulic ratcheting device, the likelihood of brittle fracture is reduced.

The present invention is comprised of a hydraulic cylinder and piston unit with a jack connected to the cylinder and piston unit on one end. A dog (such as a ratchet claw) is rotatably mounted to the jack and adapted to be received within spaced recesses (or slots) that are longitudinally spaced along the skid beam or track. The jack is integral or connected to a sliding member that moves along the skid beam. The sliding member is capable of slidably engaging with the beam, which allows the ratcheting device to push or pull objects on the beam. The slide is comprised of a top plate having slots that are adapted to allow rotation of dogs within the slot. To prevent brittle fracture of the slide (or other elements of the device), one or more hollow chambers are disposed within the slide. Heatable members are placed within the chambers that transmit heat via conduction to the rest of the device. By heating the device, the occurrence of brittle fracture is reduced and ice build up on the device is prevented, which allows for smooth movement of objects on the beam.

In another embodiment, dogs on the hydraulic device include are a first pair of opposing dogs on the sides of the jack. In another embodiment, dogs on the hydraulic device include a first pair of opposing dogs and a second pair of opposing dogs on the opposing side of the jack. The pairs of dogs on opposing sides of the jack are in tandem with each other. This arrangement of the dogs is advantageous because its spreads load forces to multiple locations on the slide and/or beam, thereby reducing the likelihood that the hydraulic device will fracture under heavy loads.

In yet another embodiment, the hydraulic ratcheting device comprises a plurality of side weldments that attach together around the beam in its assembled form. One side weldment has the jack, a pair of dogs, slots for the pair of dogs, and a portion of the slide that sandwiches on the beam. The second side weldment has a portion of the slide, and slots for dogs. The side weldments sandwich the beam and are attached to each other to form the assembled hydraulic ratcheting device. The side weldments can be separated from each other and pulled apart to remove the jack and other parts of the hydraulic ratcheting device from the beam without having to move the entire ratcheting device along length of the beam. The detachable side weldments therefore allow for easier assembly and disassembly of the device on the beam.

While the foregoing describes the present invention in relation to illustrations and examples, it is understood that it is not intended to limit the scope of the invention to the illustrations and examples described herein. On the contrary, it is intended to cover all alternative modifications and equivalents that may be included in the spirit and the scope of the invention as defined by the appended claims.

### BRIEF DESCRIPTION OF THE DRAWINGS

The above and various other objects and advantages of the invention will be described and understood from the following detailed description of the preferred embodiment of the invention, the same being illustrated in the accompanying drawings:

FIG. 1 is a perspective view of a duel ratchet jack with cartridge heaters.

FIG. 2 is a side view of a dual ratchet jack.

FIG. 3 is front view of a dual ratchet jack.

FIG. 4 is a perspective view of a first side weldment of the ratchet jack.

FIG. 5 is a perspective view of a second side weldment of the ratchet jack.

### DETAILED DESCRIPTION OF THE PREFERRED EMBODIMENT

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” and “inner” or “outer,” may be used herein to describe one element's relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

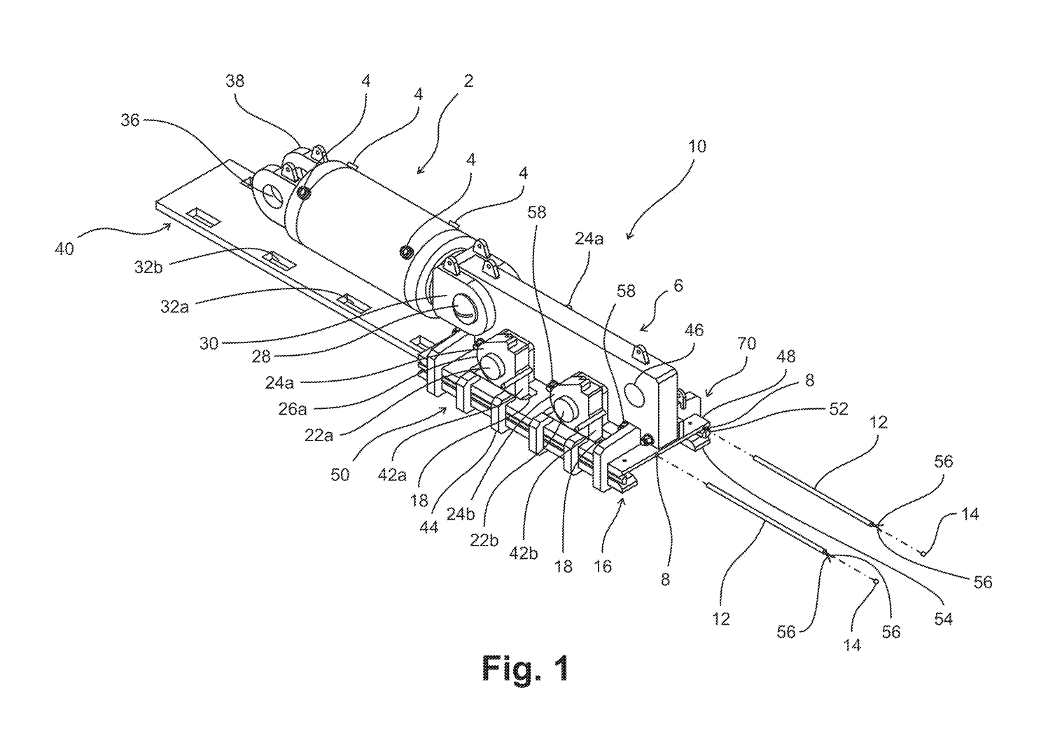

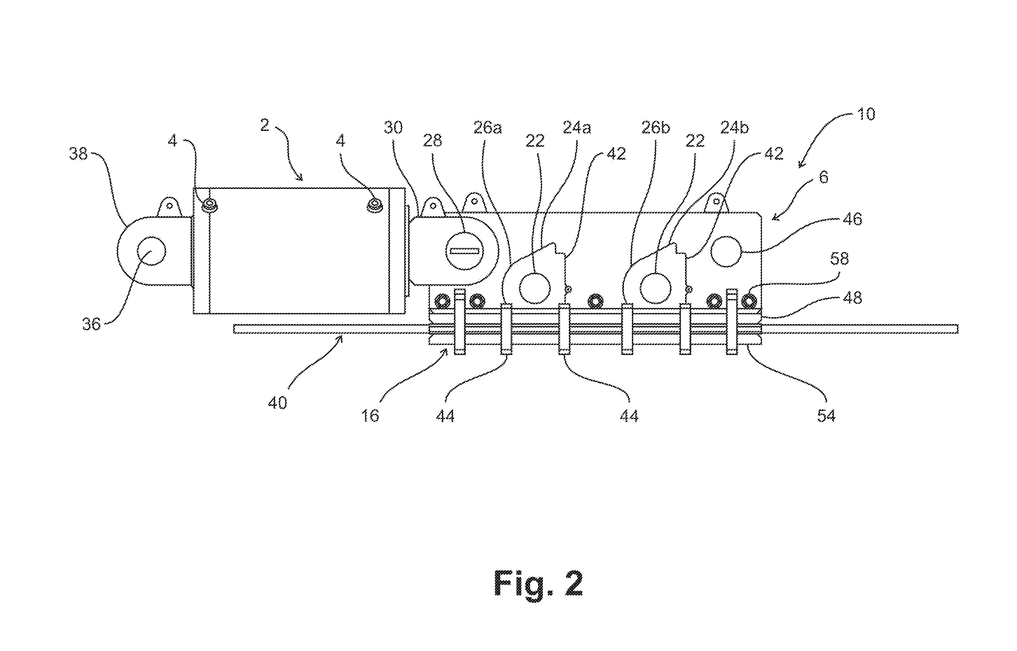

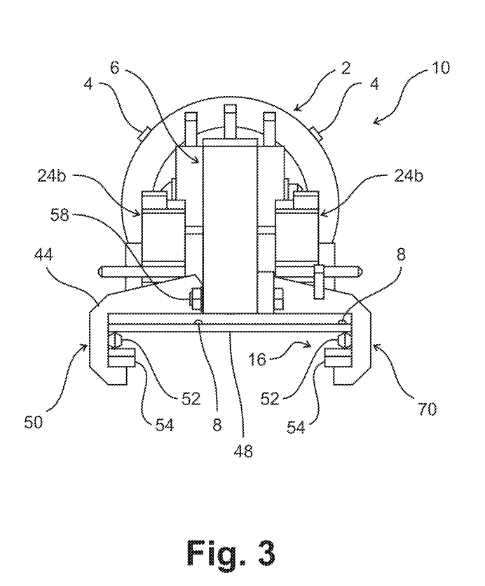

Referring to FIG. 1 an assembled duel ratchet jack 10 is shown in perspective with the beam 40 and heating elements 12. FIG. 2 shows the duel ratchet jack 10 in side view, and FIG. 3 shows that duel ratchet jack 10 in front view. Objects, such as skids, are placed on a skid beam 40 having recesses or slots 32a, 32b, and are moved in a step-by-step manner along the beam 40 by reciprocal movements of the duel ratchet jack 10 effectuated by movements within the hydraulic cylinder and piston unit 2. Objects to be moved by the device 10 are attached to lugs 38, such as a clevis mount, via an attachment device 28, such as a bolt or pin, that connects the object to be moved to the dual ratchet jack 10 through an aperture 36 in the lug 38.

The hydraulic cylinder and piston unit 2 comprises a hydraulic cylinder and piston (piston not shown, as it is within the hydraulic cylinder and piston unit 2). The piston moves within the cylinder when fluids are injected and ejected into fluid entry and exit holes 4 that move the piston back and forth within the cylinder and piston unit 2. U.S. Pat. No. 3,031,167 to Roussel; U.S. Pat. No. 3,464,095 to Chambers; and U.S. Pat. No. 4,007,915 to Chambers describe in more particular detail the mechanics of hydraulic jacking apparati, and are hereby incorporated by reference in their entirety. The mechanics of other hydraulic jacking apparatuses are commonly known in the art and a further description of the same is deemed to be unnecessary.

The hydraulic cylinder and piston unit 2 is connected on one end to an elongated jack member 6 via a second pair of lugs 30 at one end of the cylinder and piston unit 2. The jack is attached to the hydraulic cylinder and piston unit 2 via an attachment member 28, such as a pin, bolt, or screw. Attached to the jack 6 is a plurality of dogs 24a, 24b (a dog being defined as a member that prevents movement or imparts movement by offering physical obstruction or engagement of some kind). The pairs of dogs 24a, 24b are rotatably mounted to the jack 6 and adapted to be received within the spaced recesses of the beam 32a, 32b.

As illustrated, the dogs 24a, 24b are two pairs of opposing semicircular ratchet claws 24a, 24b in tandem with each other. The dogs 24a, 24b of each pair are connected via a dog pin 22a, 22b that traverses the width of the jack 6. By having multiple pairs of ratchet claws 24a, 24b, the force imparted by the skid or other objects being pushed along the beam 40 is spread over contact points instead of being focused on only one or two contact points. In the embodiment described and illustrated, there are four contact points, one point for each of the two pairs of dogs 24a, 24b, but any number of pairs of dogs can be placed on the device, with each additional pair spreading the load force over additional locations. This tandem paired orientation of dogs 24a, 24b allows the dual ratchet jack 10 to remain relatively short to effect movement of a heavy load, minimizing possible damage to underlying structures since the load forces are spread to multiple locations.

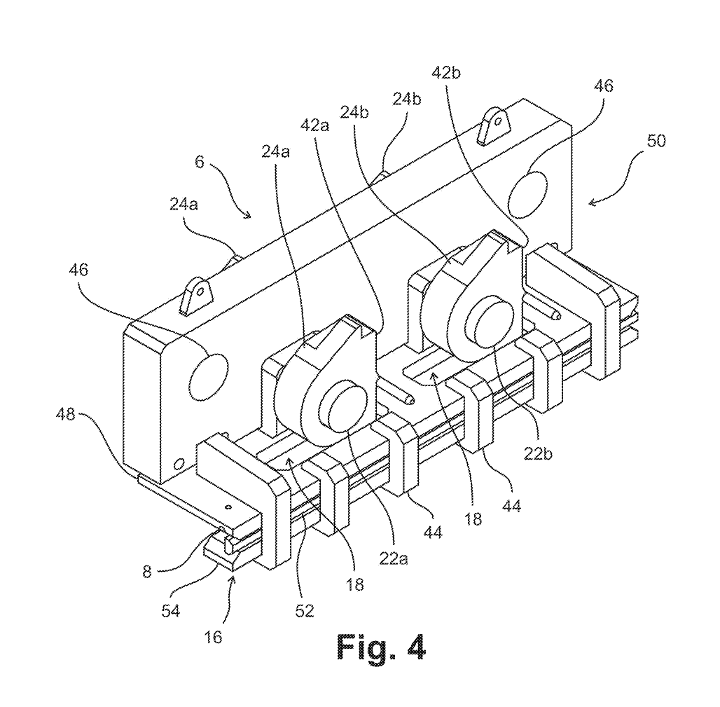

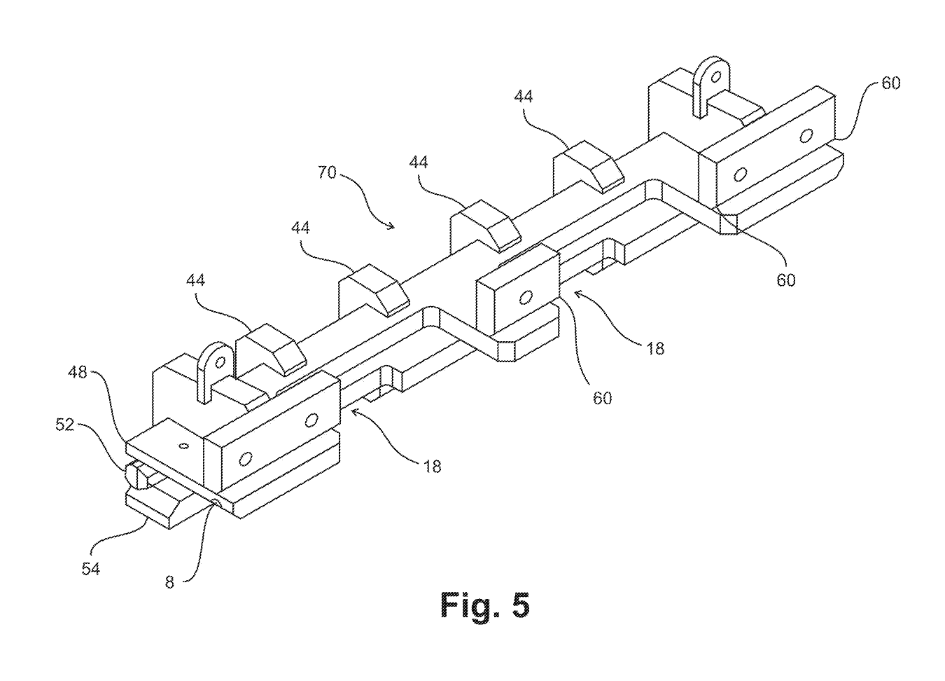

The jack 6 is integrated with, or connected to, a sliding member (or slide) 16 capable of slidably engaging with the longitudinal beam 40. The slide may be any type of object on the underside of the ratcheting device 10 that allows the device 10 to slide across the beam 40 in a relatively smooth manner. As illustrated in FIG. 1, the slide 16 has a top plate 48, and parallel opposing bottom flanges 54 that sandwich the beam 40. The top plate 48 and bottom flanges 54 are detailed in FIGS. 4 and 5, which also show a middle slide region 52 that connects the top plate 48 to the bottom flanges 54. For structural support, the slide attachment members 44 hold the top plate 48, bottom flanges 54 and middle slide region 52 together. The slide 16 allows the dual ratchet jack 10 to slide longitudinally along the slotted beam 40 and push or pull objects attached to the device 10 along the beam 40 as well.

The top plate 48 has slide slots 18 for receiving the dogs 24a, 24b adjacent to the jack 6. The device 10 moves along the beam 40 via reciprocal movement of the piston within the cylinder and piston unit 2. As the device 10 moves forward, the beam recesses 32a, 32b receive the dogs 24a, 24b. More specifically, the dogs 24a, 24b drop down into the beam recesses 32a, 32b when the beam recesses 32a, 32b, slide slots 18, and dogs 24a, 24b are all aligned. The dogs 24a, 24b can move in a forward direction (for example, from right to left, in the embodiment in FIG. 1) out of the beam slots 32a, 32b due to the dogs 24a, 24b having a curved semi-circular side 26a, 26b that allows the dogs 24a, 24b to rise and easily pass over the edge of each beam recesses 32a, 32b as the device moves forward. When the device 10 moves forward, the dogs 24a, 24b settle into the next beam recesses 32a, 32b, thus effectuating forward movement.

The device 10 is prevented from moving backwards along the beam 40 due to one side of the dogs having a flat side 42a, 42b that each brace against a flat edge of a recess 32a, 32b. Unlike the curved sides 26a, 26b, that have the capability of sliding over the flat edge of a recess 32a, 32b, the flat side 42a, 42b of the dogs 24a, 24b do not have the capability of sliding over the flat edge of the recess 32a, 32b. Thus, the reciprocal motion of the cylinder and piston unit 2 effectuates only forward motion, and not reverse motion of the device 10, and ratchets forward as the cylinder and piston unit 2 operates.

The cylinder and piston unit 2 may be attached to either end of the jack 6 since holes 46 for attaching the cylinder and piston unit 2, via an attachment member such as a pin 28, may be secured through the holes 46 on either the front or rear end of the jack 6. Thus, objects on the beam 40 may either be pushed or pulled by the ratcheting device 10 depending on which end the cylinder and piston unit 2 the jack 6 is attached to.

One problem that may occur during the movement of heavy objects (such as oil rigs, that may weigh thousands of tons), is that excess force on metal, especially during extremely cold temperatures may cause the metal of the beam or device itself to crack, known as brittle fracture. The areas most sensitive to brittle fracture in the illustrated embodiments are the regions of the slide 16 or beam 40 exposed to the greatest load stress, such as the region where the dogs 24a, 24b contact the beam 40 when in the recesses 32a, 32b.

To prevent the device 10 from dropping below a temperature that would the incidence brittle fracture, one or more regions of the device 10 has a chamber 8 for placement of a heatable member 12. The chamber 8 may be disposed in any number of convenient regions of the device, and is illustrated as being disposed within the top plate 48 of the slide 16, yet other locations, such as on the jack 6 could serve the same purpose. Any number of convenient sizes or shapes of a chamber 8 may be used. In the embodiments illustrated, the chamber 8 is a cylindrical shaft disposed longitudinally within the top plate 48 of the slide 16. Any convenient number or types of heatable members 12 may be used, but in a preferred embodiment two 2,000 watt cartridge heaters disposed within the top plate 48 has been found to be satisfactory. The heatable member 12 may be heated via electric leads 56, and in a preferred embodiment, the leads may be 240 volt AC electrical leads. The heat emanating from the heatable members 12 is initially transmitted to the top plate 48, and it is readily understandable that heat will conduct through the entirety of the slide 16, device 10, and beam 40. To prevent intrusion of unwanted material into the heating chambers 8, the chamber can be capped off by a chamber-sealing member, such as a pipe plug 14.

Along with the reduction of brittle fracture, another advantage of using heatable members 12 in the device 10 is the reduction of ice buildup along the beam 40 or device itself. Ice buildup along the beam 40 hampers smooth movement of objects placed on the beam. The use of heatable members 12 in the device 10 conducts heat along the beam 40, thereby melting ice, and advantageously providing a smoother surface on the beam 40 for objects to slide on compared to a beam that has ice buildup.

In another embodiment of the invention, the cylinder and piston unit 2 is attached to a first side weldment 50 and a second side weldment 70. The two side weldments 50, 70 are separately illustrated in FIGS. 4 and 5 respectively, and assembled together in FIG. 1. The first side weldment 50 has the jack 6, pairs of dogs 24a, 24b, and one side portion of the slide 16. The second side weldment 70 has an opposing portion of the slide 16. The first and second side weldments 50, 70 are attached together via one or more weldment attachment members 58 through one or more weldment holes 60. The detachable and removable side weldments 50, 70 allow the jack 6 and dogs 24a, 24b to be removed without having to move the ratchet device 10 along the entirety of the beam 40; instead, the side weldments 50, 70 may be pulled out away from the beam 40 horizontally and repositioned to effectuate movement of objects on the beam 40 in a different direction.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

I claim:

1. A hydraulic device for moving skids upon a support foundation of the type having a longitudinal beam with a series of longitudinally spaced recesses comprising:
a) a hydraulic cylinder and piston unit;
b) a jack connected to said cylinder and piston unit on one end;
c) a dog rotatably mounted to said jack and adapted to be received within a spaced recess of the beam;
d) a sliding member capable of slidably engaging with the longitudinal beam, said sliding member having a slot adapted to allow rotation of said dog within said slot;
e) a chamber disposed within said sliding member capable of receiving a heatable member, thereby raising the temperature of the device and reducing the likelihood of brittle fracture and ice buildup on the device and/or beam;
whereby when said dog is received within a recess in the beam, said dog allows forward, but not backward linear movement of said hydraulic device along the beam, thereby allowing said hydraulic device to ratchet forward in a step-by-step manner.

2. The hydraulic device of claim 1 wherein said dog is a first pair of opposing dogs on opposing sides of said jack,
whereby said first opposing dogs spread load forces over a greater area compared to load forces on a device having only a single dog, thereby reducing the likelihood of fracture.

3. The hydraulic device of claim 1 wherein said dog is a first pair of opposing dogs on opposing sides of said jack, and a second pair of opposing dogs on opposing sides of said jack, said second pair of opposing dogs is in tandem with said first pair of opposing dogs;
whereby said first and second pair of opposing dogs spread load forces over a greater area compared to load forces on a device having only single pair of opposing dogs, thereby reducing the likelihood of fracture.

4. The hydraulic device of claim 1, wherein said chamber is a substantially cylindrical shaft adapted to receive a heatable cartridge.

5. The hydraulic device of claim 1, wherein said sliding member comprises a top plate, a plurality of bottom flanges substantially parallel to said top plate, said top plate and said bottom flanges are configured to slidably engage with the longitudinal beam.

6. The hydraulic device of claim 1,
wherein said dog is characterized as a claw having a curved surface on a first side and substantially flat surface on a second side,
whereby said curved first side allows said dog to move in a forward direction out of a recesses in the beam, and said substantially flat second side prevents said dog from moving in a reverse direction on the beam, thereby allowing the device to ratchet in a forward direction.

7. The hydraulic device of claim 1, the device characterized as having:
a first side weldment and a second side weldment;
wherein said first side weldment comprises said jack, said dog, and a first portion of said sliding member;
wherein said second side weldment comprises a second portion of said sliding member; and,
wherein said first and second side weldment are adapted to attach and detach from each other.

8. A system for moving skids upon a support foundation comprising,
a) a hydraulic device having:
i) a hydraulic cylinder and piston unit;
ii) a jack connected to said cylinder and piston unit on one end;
iii) a dog rotatably mounted to said jack and adapted to be received within a spaced recess of the beam;
iv) a sliding member having a slot adapted to allow rotation of said dog within said slot;
v) a chamber disposed within said sliding member;
b) a heatable member adapted for placement within said chamber;
c) a beam having a plurality of longitudinally spaced recesses, said beam adapted for insertion within said sliding member, and wherein said beam is capable of being used as a support foundation for moving skids;
wherein said heatable member is capable of providing a heat source for heating said hydraulic device, thereby raising the temperature of the hydraulic device and reducing the likelihood of brittle fracture and ice buildup.

9. The system of claim 7, wherein said heatable member comprises electric leads to heat said heatable member via electrical resistance, and wherein said sliding member further comprises a chamber sealing plug for substantially sealing said chamber.

10. The system of claim 7, wherein said plurality of longitudinally spaced recesses along said beam are a plurality of longitudinally spaced slots.

11. A system for moving skids upon a support foundation comprising,
a) a hydraulic device having:
i) a hydraulic cylinder and piston unit;
ii) a jack connected to said cylinder and piston unit on one end;
iii) two or more pairs of dogs rotatably mounted to said jack and adapted to be received within a spaced recess of the beam;
iv) a sliding member having a slot adapted to allow rotation of said dog within said slot;
v) a chamber disposed within said sliding member;
b) a heatable member adapted for placement within said chamber;
c) a beam having a plurality of longitudinally spaced recesses, said beam adapted for insertion within said sliding member, and wherein said beam is capable of being used as a support foundation for moving skids;
wherein said heatable member is capable of providing a heat source for heating said hydraulic device, thereby raising the temperature of the hydraulic device and reducing the likelihood of brittle fracture and ice buildup;
wherein said heatable member comprises electric leads to heat said heatable member via electrical resistance, and wherein said sliding member further comprises a chamber sealing plug for substantially sealing said chamber.
